(19) United States
(12) Patent Application Publication
(10) Pub. No.: US 2021/0140686 A1
(43) Pub. Date: May 13, 2021

(54) ELECTROCALORIC HEAT TRANSFER SYSTEM WITH EMBEDDED ELECTRONICS

(71) Applicant: Carrier Corporation, Palm Beach Gardens, FL (US)

(72) Inventors: Joseph V. Mantese, Ellington, CT (US); Subramanyaravi Annapragada, South Windsor, CT (US); Slade R. Culp, Coventry, CT (US); Sameh Dardona, South Windsor, CT (US); Scott Alan Eastman, Glastonbury, CT (US); Wayde R. Schmidt, Pomfret Center, CT (US); Parmesh Verma, South Windsor, CT (US); Craig R. Walker, South Glastonbury, CT (US); Wei Xie, Manchester, CT (US)

(21) Appl. No.: 16/623,330

(22) PCT Filed: Jun. 18, 2018
(86) PCT No.: PCT/US2018/038044

§ 371 Date: Dec. 16, 2019

Related U.S. Application Data
(60) Provisional application No. 62/521,171, filed on Jun. 16, 2017.

(51) Int. Cl. F25B 21/00

(52) U.S. Cl. CPC F25B 21/00; F25B 2321/001

(57) ABSTRACT

An electrocaloric module includes a housing and an electrocaloric element in the housing. The electrocaloric element includes an electrocaloric film, a first electrode on a first surface of the electrocaloric film, and a second electrode on a second surface of the electrocaloric film. The electrocaloric module also includes a first thermal connection configured to connect to a first thermal flow path between the electrocaloric elements and a heat sink, a second thermal connection configured to connect to a second thermal flow path between the electrocaloric elements and a heat source, and a power connection connected to the first and second electrodes and configured to connect to a power source.

### BACKGROUND

A wide variety of technologies exist for cooling applications, including but not limited to evaporative cooling, convective cooling, or solid state cooling such as electrothermic cooling. One of the most prevalent technologies in use for residential and commercial refrigeration and air conditioning is the vapor compression refrigerant heat transfer loop. These loops typically circulate a refrigerant having appropriate thermodynamic properties through a loop that comprises a compressor, a heat rejection heat exchanger (i.e., heat exchanger condenser), an expansion device and a heat absorption heat exchanger (i.e., heat exchanger evaporator). Vapor compression refrigerant loops effectively provide cooling and refrigeration in a variety of settings, and in some situations can be run in reverse as a heat pump. However, many of the refrigerants can present environmental hazards such as ozone depleting potential (ODP) or global warming potential (GWP), or can be toxic or flammable. Additionally, vapor compression refrigerant loops can be impractical or disadvantageous in environments lacking a ready source of power sufficient to drive the mechanical compressor in the refrigerant loop. For example, in an electric vehicle, the power demand of an air conditioning compressor can result in a significantly shortened vehicle battery life or driving range. Similarly, the weight and power requirements of the compressor can be problematic in various portable cooling applications.

Accordingly, there has been interest in developing cooling technologies as alternatives to vapor compression refrigerant loops. Various technologies have been proposed such as field-active heat or electric current-responsive heat transfer systems relying on materials such as electrocaloric materials, magnetocaloric materials, or thermoelectric materials. However, many proposals have been configured as bench-scale demonstrations with limited capabilities.

### BRIEF DESCRIPTION

In some embodiments of this disclosure, an electrocaloric module comprises a housing and an electrocaloric element in the housing. The electrocaloric element comprises an electrocaloric film, a first electrode on a first surface of the electrocaloric film, and a second electrode on a second surface of the electrocaloric film. The electrocaloric module also includes a first thermal connection configured to connect to a first thermal flow path between the electrocaloric element and a heat sink, a second thermal connection configured to connect to a second thermal flow path between the electrocaloric element and a heat source, a power connection connected to the first and second electrodes and configured to connect to a power source, and an electronic component embedded in the electrocaloric module.

In some embodiments, a heat transfer system comprises the above-described electrocaloric module, a first thermal flow path between the electrocaloric elements and a heat sink through the first thermal connection, a second thermal flow path between the electrocaloric elements and a heat source through the second thermal connection, an electrical connection between a power source and the electrodes further through the power connection, and a controller configured to selectively apply voltage to activate the electrodes in coordination with heat transfer along the first and second thermal flow paths to transfer heat from the heat source to the heat sink.

In some embodiments, the heat transfer system controller is configured to direct power to or receive a signal from the electronic component.

In some embodiments, a method of making an electrocaloric module comprises fabricating an electrocaloric element comprising an electrocaloric film, a first electrode on a first surface of the electrocaloric film, and a second electrode on a second surface of the electrocaloric film, and disposing the electrocaloric element in a housing. Further according to the method, a first thermal connection is provided configured to connect to a first thermal flow path between the electrocaloric element and a heat sink, a second thermal connection is provided configured to connect to a second thermal flow path between the electrocaloric element and a heat source, and a power connection is provided connected to the electrodes and configured to connect to a power source to form an electrocaloric module. The method further includes embedding an electronic component embedded in the electrocaloric module.

According to some embodiments, a method of making a heat transfer system, comprising making an electrocaloric module according to the above-described method, connecting the first thermal connection to a heat sink, connecting the second thermal connection to a heat sink, connecting the second thermal connection to a heat source, connecting the electrical connection to a power source, and connecting a controller to the electrodes and the thermal connections, said controller configured to selectively apply voltage to activate the electrodes in coordination with heat transfer along the first and second thermal flow paths to transfer heat from the heat source to the heat sink.

According to any one or combination of the above embodiments, the electrocaloric module can comprise a plurality of electrocaloric elements that individually comprise an electrocaloric film, a first electrode on a first surface of the electrocaloric film, and a second electrode on a second surface of the electrocaloric film.

In some embodiments, a method of transferring heat comprises selectively applying voltage to activate electrodes on first and second surfaces of an electrocaloric material disposed in an electrocaloric module. Further according to the method, heat is transferred, in coordination with application of voltage to the electrodes, from a heat source to the electrocaloric material and from the electrocaloric material to a heat sink. The method also includes supplying electric power to, or receiving a signal from, or supplying electric power to and receiving a signal from an electronic component embedded in the electrocaloric module.

According to any one or combination of the above embodiments, the electronic component can comprise a passive electronic component.

According to any one or combination of the above embodiments, the electronic component can be selected from a resistor, a diode, a Zener diode, a resistance temperature detector, an inductor, a capacitor, a piezoelectric element, a current sensor, a positive temperature coefficient of resistance element, a fusible link, or interdigitated electrodes.

According to any one or combination of the above embodiments, the electronic component can comprise a positive temperature coefficient of resistance element or a fusible link in the connection between the electrical power source and the electrodes.

According to any one or combination of the above embodiments, the electronic component can comprise a resistance temperature detector, a piezoelectric element, a sensor to measure electric dissipation, a sensor to measure current through the circuit and the circuit's quiescent electrical discharge, a noise sensor, an acoustic sensor, a voltage sensor, or an electrical arc sensor.

According to any one or combination of the above embodiments, the electronic component can comprise interdigitated electrodes.

According to any one or combination of the above embodiments, the electronic component can be integrated with or affixed to the electrocaloric element.

According to any one or combination of the above embodiments, the electronic component can be separate from electrocaloric elements.

### BRIEF DESCRIPTION OF THE DRAWINGS

Subject matter of this disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic depiction of a top view of an example embodiment of an electrocaloric heat transfer module;

FIG. 2 is a schematic depiction of a cross-sectional side view of the module of FIG. 1;

FIG. 3 is a schematic depiction of an example embodiment of an electrocaloric heat transfer system;

FIG. 4 is a schematic depiction of an electrocaloric element from the view of FIG. 2, including an embedded electronic component;

FIG. 5A is a schematic depiction of a top view of an embedded electronic component comprising interdigitated electrode, FIG. 5B represents a schematic depiction of cross-section side view of interdigitated electrodes on opposite sides of an electrocaloric film, and FIG. 5C represents a schematic depiction of cross-section side view of interdigitated electrodes on the same side of an electrocaloric film; and

FIGS. 6A, 6B, and 6C each represents a schematic depiction of an embedded electronic component comprising electrodes on surfaces of an electrocaloric material.

### DETAILED DESCRIPTION

As mentioned above, a heat transfer system is disclosed that includes an electrocaloric module. An example of an embodiment of a module is schematically depicted in FIGS. 1 and 2. Although any directions described herein (e.g., “up”, “down”, “top”, “bottom”, “left”, “right”, “over”, “under”, etc.) are considered to be arbitrary and to not have any absolute meaning but only a meaning relative to other directions, FIG. 1 can be described as a “bottom” view of an example embodiment of a module and FIG. 2 can be described as a “side” cross-section view taken along the line A⇄A shown in FIG. 1. As shown in FIGS. 1 and 2, an electrocaloric module 10 comprises an electrocaloric element that comprises an electrocaloric film 12, a first electrode 14 on a first side of the film and a second electrode 16 on a second side of the film, disposed in a housing 17. It is noted that, for ease of illustration so that details of the electrocaloric film 12 and other components are not obscured, the electrodes 14, 16 are omitted from FIG. 1 and are only illustrated in FIGS. 2 and 4.

The electrocaloric film 12 can comprise any of a number of electrocaloric materials. In some embodiments, electrocaloric film thickness can be in a range having a lower limit of 0.1 μm, more specifically 0.5 μm, and even more specifically 1 μm. In some embodiments, the film thickness range can have an upper limit of 1000 μm, more specifically 100 μm, and even more specifically 10 μm. It is understood that these upper and lower range limits can be independently combined to disclose a number of different possible ranges. Examples of electrocaloric materials for the electrocaloric film can include but are not limited to inorganic materials (e.g., ceramics), electrocaloric polymers, and polymer/ceramic composites. Examples of inorganics include but are not limited to PbTiO₃ (“PT”), Pb(Mg_{1/3}Nb_{2/3})O₃ (“PMN”), PMN-PT, LiTaO₃, barium strontium titanate (BST) or PZT (lead, zirconium, titanium, oxygen). Examples of electrocaloric polymers include, but are not limited to ferroelectric polymers, liquid crystal polymers, and liquid crystal elastomers.

Ferroelectric polymers are crystalline polymers, or polymers with a high degree of crystallinity, where the crystalline alignment of polymer chains into lamellae and/or spherulite structures can be modified by application of an electric field. Such characteristics can be provided by polar structures integrated into the polymer backbone or appended to the polymer backbone with a fixed orientation to the backbone. Examples of ferroelectric polymers include polyvinylidene fluoride (PVDF), polytriethylene fluoride, odd-numbered nylon, copolymers containing repeat units derived from vinylidene fluoride, and copolymers containing repeat units derived from triethylene fluoride. Polyvinylidene fluoride and copolymers containing repeat units derived from vinylidene fluoride have been widely studied for their ferroelectric and electrocaloric properties. Examples of vinylidene fluoride-containing copolymers include copolymers with methyl methacrylate, and copolymers with one or more halogenated co-monomers including but not limited to trifluoroethylene, tetrafluoroethylene, chlorotrifluoroethylene, trichloroethylene, vinylidene chloride, vinyl chloride, and other halogenated unsaturated monomers.

Liquid crystal polymers, or polymer liquid crystals comprise polymer molecules that include mesogenic groups. Mesogenic molecular structures are well-known, and are often described as rod-like or disk-like molecular structures having electron density orientations that produce a dipole moment in response to an external field such as an external electric field. Liquid crystal polymers typically comprise numerous mesogenic groups connected by non-mesogenic molecular structures. The non-mesogenic connecting structures and their connection, placement and spacing in the polymer molecule along with mesogenic structures are important in providing the fluid deformable response to the external field. Typically, the connecting structures provide stiffness low enough so that molecular realignment is induced by application of the external field, and high enough to provide the characteristics of a polymer when the external field is not applied.

In some exemplary embodiments, a liquid crystal polymer can have rod-like mesogenic structures in the polymer backbone separated by non-mesogenic spacer groups having flexibility to allow for re-ordering of the mesogenic groups in response to an external field. Such polymers are also known as main-chain liquid crystal polymers. In some exemplary embodiments, a liquid crystal polymer can have rod-like mesogenic structures attached as side groups attached to the polymer backbone. Such polymers are also known as side-chain liquid crystal polymers.

With continued reference to FIG. 1, first electrode 14 is electrically connected to a first electrical bus element 18. Similarly, second electrode 16 is electrically connected to second electrical bus element 20. The bus elements include a power connection (not shown) configured to an electric power source (not shown). The electrodes can be any type of conductive material, including but not limited to metallized layers of a conductive metal such as aluminum or copper, or other conductive materials such as carbon (e.g., carbon nanotubes, graphene, or other conductive carbon). Noble metals can also be used, but are not required. Other conductive materials such as a doped semiconductor, ceramic, or polymer, or conductive polymers can also be used.

One or more support elements 22 can optionally be included for support and retention of the electrocaloric element. However, separate support elements are not required, as support and retention can also be provided by the bus elements as shown in FIG. 2 described below. As shown in FIG. 1, the support element(s) 22 can be configured to provide header spaces 24 and 26 for transport of working fluids to and from the electrocaloric element along fluid flow path 25. Although not required in all design configurations, in some embodiments, the support elements can be made from an electrically non-conductive material. Spacer elements 28 can optionally be included to help maintain separation from adjacent electrocaloric elements for a fluid flow path for a working fluid (e.g., either a fluid to be heated or cooled directly such as air, or a heat transfer fluid such as a dielectric organic compound). Any configuration of spacer elements can be utilized, such as a set of discrete disk spacer elements or linear or non-linear axially extending spacer elements.

Turning now to FIG. 2 where like numbering is used as FIG. 1, the module 10 is shown as comprising a number of electrocaloric elements assembled together in a stack. As can be seen in FIG. 3, the spacers promote maintaining a physical separation between adjacent electrocaloric elements to provide a fluid flow path 25 between the spacers and the adjacent electrocaloric elements. Although not required in all design configurations, in design configurations where the spacer elements are disposed adjacent to electrodes of opposite polarity, the spacer elements can be made from an electrically non-conductive material. In some embodiments, adjacent electrical bus elements 18, 20 can have an interlocking configuration (with complementary contour of projections and recesses where a projection of one bus element projects is adjacent or projects into to a complementary recess of an adjacent bus element) as shown in FIG. 2. The electrical bus elements fit together to form bus bars that are connected through electrical connections (not shown) to an electrical power source (not shown). The bus bars can also serve as housing 17 if they are insulated on the outer surface.

An example embodiment of a heat transfer system and its operation are further described with respect to FIG. 3. As shown in FIG. 3, a heat transfer system 300 comprises an electrocaloric module 310 such as the module 10 of FIGS. 1 and 2 or another configuration. The electrocaloric element is in thermal communication with a heat sink 317 through a first thermal flow path 318, and in thermal communication with a heat source 320 through a second thermal flow path 322. The thermal flow paths are described below with respect thermal transfer through flow of a heat transfer fluid through control valves 326 and 328 between the electrocaloric element and the heat sink and heat source, but can also be through conductive heat transfer through solid state heat thermoelectric switches in thermally conductive contact with the electrocaloric element and the heat source or heat sink, or thermomechanical switches in movable to establish thermally conductive contact between the electrocaloric element and the heat source or heat sink. A controller 324 is configured to control electrical current to through a power source (not shown) to selectively activate the electrodes 314, 316. The controller 324 is also configured to open and close control valves 326 and 328 to selectively direct the heat transfer fluid along the first and second flow paths 318 and 322.

In operation, the system 310 can be operated by the controller 324 applying an electric field as a voltage differential across the electrocaloric element to cause a decrease in entropy and a release of heat energy by the electrocaloric elements. The controller 324 opens the control valve 326 to transfer at least a portion of the released heat energy along flow path 318 to heat sink 317. This transfer of heat can occur after the temperature of the electrocaloric elements has risen to a threshold temperature. In some embodiments, heat transfer to the heat sink 317 is begun as soon as the temperature of the electrocaloric elements increases to be about equal to the temperature of the heat sink 317. After application of the electric field for a time to induce a desired release and transfer of heat energy from the electrocaloric elements to the heat sink 317, the electric field can be removed. Removal of the electric field causes an increase in entropy and a decrease in heat energy of the electrocaloric elements. This decrease in heat energy manifests as a reduction in temperature of the electrocaloric elements to a temperature below that of the heat source 320. The controller 324 closes control valve 326 to terminate flow along flow path 318, and opens control device 328 to transfer heat energy from the heat source 320 to the colder electrocaloric elements in order to regenerate the electrocaloric elements for another cycle.

In some embodiments, for example where a heat transfer system is utilized to maintain a temperature in a conditioned space or thermal target, the electric field can be applied to the electrocaloric elements to increase its temperature until the temperature of the electrocaloric element reaches a first threshold. After the first temperature threshold, the controller 324 opens control valve 326 to transfer heat from the electrocaloric elements to the heat sink 317 until a second temperature threshold is reached. The electric field can continue to be applied during all or a portion of the time period between the first and second temperature thresholds, and is then removed to reduce the temperature of the electrocaloric elements until a third temperature threshold is reached. The controller 324 then closes control valve 326 to terminate heat flow transfer along heat flow path 318, and opens control valve 328 to transfer heat from the heat source 320 to the electrocaloric elements. The above steps can be optionally repeated until a target temperature of the conditioned space or thermal target (which can be either the heat source or the heat sink) is reached.

With reference now to FIG. 4, a side view of a side view of an electrocaloric element is schematically depicted. As shown in FIG. 4, first electrode 14 is electrically connected to a first electrical bus element 18. Similarly, second electrode 16 is electrically connected to second electrical bus element 20. The electrodes can be any type of conductive material, including but not limited to metallized layers of a conductive metal such as aluminum or copper, or other conductive materials such as carbon (e.g., carbon nanotubes, graphene, or other conductive carbon). Noble metals can also be used, but are not required. Other conductive materials such as a doped semiconductor, ceramic, or polymer, or conductive polymers can also be used. The electrodes 14 and 16 shown in FIG. 4 can extend from a position in contact with an electrical bus element on one edge of the film and extend across the film to a position that is not in contact with the electrical bus element of opposite polarity on the other edge of the film 12.

As mentioned above, the electrocaloric module includes an embedded electronic component. In this context, the term “embedded” does not refer to components that are buried or partially buried in a material, although such buried components are not excluded either. Instead, as used herein, the term embedded describes a system configuration relationship between the electronic component and the electrocaloric module in which the embedded component is configured so as to not be directly involved in the generation or transmission of heat energy, but is instead configured to perform an ancillary or secondary function associated with generation or transfer of heat energy or other aspects of system operation. For example, the primary electrodes 14 and 16 are not considered to be embedded electronic components, nor would electrically-activated thermal switches for conductive heat transfer be considered as embedded components. However, many other types of electronic components can be embedded, including but not limited to resistors, diodes, Zener diodes, resistance temperature detectors (RTD), inductors, capacitors, a piezoelectric elements, current sensors, positive temperature coefficient of resistance elements (PTCR), fusible links, or interdigitated electrodes. With reference to FIG. 4, an electronic component 32 is shown embedded in the electrical connection between the bus element 18 and the electrode 14. In some embodiments, the electronic component 32 can be an electrical current protection or control device such as a positive temperature coefficient of resistance (PTCR) element or a fusible link. A PTCR element can control current and protect it from reaching potentially damaging levels with increased resistance as a function of increased temperature. As used herein the term “fusible link” means an electrical link that acts like a fuse to disconnect the module element from the power source thereby protecting the electrocaloric element. In some embodiments, the electronic component 32 can be a sensor or measurement device, in which case it can have a connection such as a wireless signal connection with a controller such as controller 324 (FIG. 3). Sensors or measurement devices that can be disposed in the electrical connection to the electrode(s) such as electronic component 32 can include electrical current sensors, a resistance temperature detector, a piezoelectric element, a sensor to measure electric dissipation, a sensor to measure current through the circuit and the circuit's quiescent electrical discharge, a noise sensor, an acoustic sensor, a voltage sensor, or an electrical arc sensor. In some embodiments, an electronic component can be embedded in the module in contact with the electrocaloric film 12, such as shown for electronic component 34. In some embodiments, the electronic component 34 can be a sensor to measure one or more properties of the electrocaloric material such as temperature, resistivity, capacitance, current, or voltage. The sensor 34 can be connected to an electrical power source through electrical connections (not shown) and can be connected to a controller such as controller 324 (FIG. 3) through the same electrical connections or wirelessly.

In some embodiments, an embedded electronic component such as electronic component 34 can comprise electrodes with electrocaloric material between the electrodes. In some embodiments, the electrodes can comprise interdigitated electrodes on the electrocaloric film surface or opposing surfaces. In some embodiments, the electrodes can comprise film or plate structures on opposing film surfaces to form a capacitor-like structure. Example embodiments of interdigitated electrodes are schematically shown in FIGS. 5A, 5B, and 5C. As shown in FIG. 5A, interdigitated electrodes 36 and 38 are shown in a top view on electrocaloric film 12. Electrical connectors 40 and 42 provide a connection to a power source and/or controller (not shown). The interdigitated electrodes 36 and 38 can be on the same side of the electrocaloric film 12 as shown in FIG. 5B, or on opposite sides of the electrocaloric film 12 as shown in FIG. 5C. In some embodiments, the spacing between the individual fingers of each electrode can range from 0.5 times the film thickness to 5 times the film thickness. In some embodiments, such electrode finger spacing can provide a technical effect of promoting distribution through the electric film of an electric field formed when the electrodes are powered.

In operation, electrodes such as the interdigitated electrodes 36 and 38 can be used for various purposes such as measuring pyroelectric coefficient, bulk resistivity (FIG. 5C electrodes), surface resistivity/conductivity, (FIG. 5B electrodes) for detecting arcing conditions to which the primary electrodes 14 and 16 (FIG. 4) may be subjected or for detecting the presence of water at the film surface, electrocaloric material breakdown strength, electrocaloric material dielectric constant (e.g., to monitor for dielectric loss). An example embodiment of a circuit configuration for electrodes is schematically depicted in FIG. 6. As shown in FIG. 6, electrodes 44 and 46 are disposed on opposite sides of the electrocaloric film 12 in a capacitor-like structure. The electrodes 44 and 46 are shown as non-interdigitated structures, but interdigitated electrodes could be used. A detector 48 is connected to the electrodes to receive and amplify an electrical signal. For example, the capacitor-like structure can produce a piezoelectric effect from dimensional changes to the electrocaloric film 12 (e.g., the film gets thinner when stretched) that can be used to detect fluid pressure variations in the electrocaloric module or electrostrictive dimensional variations that affect the electrocaloric film 12 during operation. Measurement of other properties (e.g., current, voltage, dissipation, resistance, temperature, strain, etc.) can be accomplished by generating an interrogation signal from an interrogation circuit 50, which includes an AC or DC power source 52 to provide excitation to the electrodes and one or more circuit elements 54 (e.g., resistor, capacitor, inductor), and then measuring the response at detector 48. The circuit element can also be located at the position designated by the lead line for number 50 used for to label the interrogation circuit, as its position is flexible.

In some embodiments, an electronic component can be embedded in the electrocaloric module physically separated from the electrocaloric elements. An example embodiment is shown in FIG. 1 of an electronic component 56 connected by electrical connection 58 to a power source/controller (not shown). Electronic component 56 is disposed in the header space 26 of the electrocaloric module 10 and can include, for example, a fluid temperature sensor (e.g., an RTD) or a fluid pressure sensor. Also, many of the above-described electronic components are passive components that do not involve signal amplification. However, active components such as transistors, semiconductor circuit chips, microprocessors, etc., can also be embedded.

Electronic components can be embedded in an electrocaloric module by various manufacturing techniques, and can be done at any stage of the manufacturing process. For example, electronic components that are integrated with the electrical connections to electrodes 14 and 16 can be deposited as part of the electrode fabrication and attachment process. Electronic components that are attached to or integrated with the electrocaloric film can be glued, printed, deposited (e.g., vapor deposition), or glued directly onto the film. In some embodiments, the electronic component and conductive traces for the component's electrical connections can be fabricated onto a transfer film, which can then be contacted with the electrocaloric film to transfer the component and conductive traces onto the electrocaloric film. Electronic components that are separate from the electrocaloric elements can be fabricated and installed by various conventional fabrication techniques (e.g., hole boring, brazing, etc.).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An electrocaloric module, comprising:
a housing;
an electrocaloric element in the housing, comprising an electrocaloric film, a first electrode on a first surface of the electrocaloric film, and a second electrode on a second surface of the electrocaloric film;
a first thermal connection configured to connect to a first thermal flow path between the electrocaloric element and a heat sink;
a second thermal connection configured to connect to a second thermal flow path between the electrocaloric element and a heat source;
a power connection connected to the electrodes configured to connect to a power source; and
an electronic component embedded in the electrocaloric module.

2. A heat transfer system comprising the electrocaloric module of claim 1, a first thermal flow path between the electrocaloric elements and a heat sink through the first thermal connection, a second thermal flow path between the electrocaloric elements and a heat source through the second thermal connection, an electrical connection between a power source and the electrodes further through the power connection, and a controller configured to selectively apply voltage to activate the electrodes in coordination with heat transfer along the first and second thermal flow paths to transfer heat from the heat source to the heat sink.

3. The heat transfer system of claim 2, wherein the controller is configured to direct power to or receive a signal from the electronic component.

4. A method of making an electrocaloric module, comprising:
fabricating an electrocaloric element comprising an electrocaloric film, a first electrode on a first surface of the electrocaloric film, and a second electrode on a second surface of the electrocaloric film;
disposing the electrocaloric element in a housing, and providing a first thermal connection configured to connect to a first thermal flow path between the electrocaloric element and a heat sink, a second thermal connection configured to connect to a second thermal flow path between the electrocaloric element and a heat source, and a power connection connected to the electrodes configured to connect to a power source; and
embedding an electronic component embedded in the electrocaloric module.

5. A method of making a heat transfer system, comprising making an electrocaloric module according to the method of claim 4, connecting the first thermal connection to a heat sink, connecting the second thermal connection to a heat sink, connecting the second thermal connection to a heat source, connecting the electrical connection to a power source, and connecting a controller to the electrodes and the thermal connections, said controller configured to selectively apply voltage to activate the electrodes in coordination with heat transfer along the first and second thermal flow paths to transfer heat from the heat source to the heat sink.

6. The electrocaloric module of claim 1, wherein the electrocaloric module comprises a plurality of electrocaloric elements that individually comprise an electrocaloric film, a first electrode on a first surface of the electrocaloric film, and a second electrode on a second surface of the electrocaloric film.

7. A method of transferring heat, comprising:
selectively applying voltage to activate electrodes on first and second surfaces of an electrocaloric material disposed in an electrocaloric module;
in coordination with application of voltage to the electrodes, transferring heat from a heat source to the electrocaloric material and from the electrocaloric material to a heat sink;
and supplying electric power to, or receiving a signal from, or supplying electric power to and receiving a signal from an electronic component embedded in the electrocaloric module.

8. The electrocaloric module of claim 1, wherein the electronic component comprises a passive electronic component.

9. The electrocaloric module of claim 1, wherein the electronic component is selected from a resistor, a diode, a Zener diode, a resistance temperature detector, an inductor, a capacitor, a piezoelectric element, a current sensor, a positive temperature coefficient of resistance element, a fusible link, or interdigitated electrodes.

10. The electrocaloric module of claim 9, wherein the electronic component comprises a positive temperature coefficient of resistance element or a fusible link in the connection between the electrical power source and the electrodes.

11. The electrocaloric module of claim 9, wherein the electronic component comprises a resistance temperature detector.

12. The electrocaloric module of claim 9, wherein the electronic component comprises interdigitated electrodes.

13. The electrocaloric module of claim 1, wherein the electronic component is integrated with or affixed to the electrocaloric element.

14. The electrocaloric module of claim 1, wherein the electronic component is separate from electrocaloric elements.
